(19) United States
(12) Patent Application Publication
(10) Pub. No.: US 2010/0114638 A1
(43) Pub. Date: May 6, 2010

(54) Method and Software for the Measurement of Quality of Process

(75) Inventor: Yegor Bugayenko, Naples, FL (US)

Correspondence Address: Technopark Corporation, 568 Ninth Street South 202, Naples, FL, 34102, US

(73) Assignee: TECHNOPARK CORPORATION, Naples, FL (US)

(21) Appl. No.: 12/264,370

(22) Filed: Nov. 4, 2008

(51) Int. Cl. G06Q 10/00

(52) U.S. Cl. 705/8; 705/11

(57) ABSTRACT

The invented method and software consolidate and automate the mechanism of quality of process (QoP) measurement in software development projects, and in any other business activity. Quality policy is defined as a collection of quality requirements, with software modules, that automatically calculate the value of each quality metric. Weighted average of all quality metrics is a QoP indicator, which can be used for project monitoring, team motivation and business feasibility study.

### BACKGROUND

1. Field

The present invention relates generally to the quality of process measurement in software development projects, and project management and control in general.

2. Prior Art

Quality of Process (QoP) in software projects is measured as a compliance to a set of pre-defined standards [3]. There are a number of such industry-wide standards, while some of them are more precise, others less. Good examples are CMMI [1], ISO-9000 family of standards [8], IEEE standards [5, 6, 4, 7], Unified Modeling Language (UML) [9], coding rules and conventions [11].

The selecting of the right standards, applicable to a given project, is a complicated task for a project manager. However, a much more difficult task is to keep the project (team, artifacts, results, processes) compliant to the selected set of standards during the whole project lifecycle. What is almost impossible for the majority of projects is a regular reporting of that level of compliance. Senior management and project stakeholders would like to know how compliant is the given project to the standards required. In other words, what is the QoP, on a numeric scale.

Industry leading project and portfolio management tools, such as Primavera P6 [10] and Rational Portfolio Manager [2] do not give much help in this task of QoP measurement. There are a lot of solutions for project management on the market [12], but none of them provide the ability to measure and track the QoP.

Some of them give the ability to check the status of certain artifacts, some perform automated health checks of project results, but none of them integrate all metrics into one centralized QoP indicator.

Without such consolidated QoP measurement neither project manager nor project stakeholders may get a clear understanding of how compliant the project is to the standards defined.

### SUMMARY

The invented Method and Software for the Measurement of Quality of Process includes a full cycle of QoP measurement, including a quality requirements definition, quality metrics collection, numeric calculations and team motivation.

Project standards are defined as a list of measurable quality requirements. Each quality requirement has its own software module, which calculates the value of quality metric, on the fly. All metrics are calculated in some numeric interval, e.g. from 1 to 5.

Each quality requirement has a weight, which designates the importance of this requirement to the overall QoP.

At any given moment of time QoP is calculated automatically as a weighted average of all quality metrics. This QoP measurement is delivered to the project manager, senior management and project stakeholders. The QoP measurement is a good basis for project manager and project team motivation.

This approach could be applied not only to projects, but to other business processes, which have a number of measurable quality requirements.

The invention was successfully implemented in “thePanel” web software, manufactured by TechnoPark Corp.

### SHORT Description of Drawings

FIG. 1 is a sample screenshot of thePanel software, with a list of quality requirements and metrics for Scope Management process area;

FIG. 2 is a screenshot of thePanel software page with a QA Review document that contains all quality requirements and metrics for a given project;

FIG. 3 shows a screenshot with quality requirement calculation protocol visible for all project stakeholders;

FIG. 4 shows a screenshot with quality requirement discussion board;

FIG. 5 is a sample XML document with a list of quality requirements, weights and references to process areas;

FIG. 6 contains one sample quality requirement with quality metric;

FIG. 7 visually presents the interconnection between process areas quality and project quality;

FIG. 8 has a time graph of changing of QoP for a project, with visually indicated threshold;

FIG. 9 shows how thePanel components are organized architecturally;

FIG. 10 shows the interaction between end-user, web browser, internal thePanel cache, Quality Metric Calculation Module and data;

FIG. 11 presents a sample mapping of CMMI Specific Practice to quality requirement used later in the invented method.

### DETAILED DESCRIPTION OF DRAWINGS

While this invention is susceptible to embodiment in many different forms, there are shown in the drawing, and will be described herein in detail, specific embodiments thereof with the understanding that the present disclosure is to be considered as an exemplification of the principles of the invention and is not intended to limit the invention to the specific embodiments illustrated.

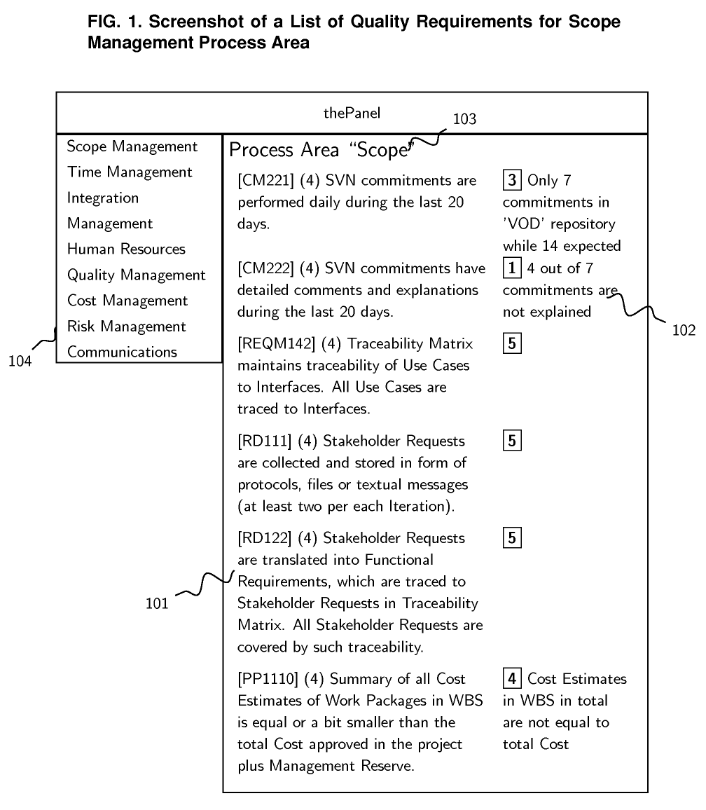

FIG. 1 has a sample screenshot of thePanel web-based software, manufactured by TechnoPark Corp. This system interconnects project managers, project stakeholders and senior management in one web space, sharing artifacts. The screenshot has a list of quality requirements (pin 101) together with quality metrics (pin 102), calculated for the Scope Management process area (pin 103).

Quality metrics (equals to “3” in pin 102) are calculated in [1; 5] intervals, where the lowest boundary means the lowest quality. All metrics on the web page are calculated by thePanel software in automatic background model. The end-user (project manager, programmer, tester, customer, director of the company, etc) sees just the result of such a calculation. This result is an atomic measurement of quality of process.

ThePanel software also provides comments for each quality metric, which helps project managers to make necessary changes, in order to improve the quality. For example, in pin 102 the comment is “2 of 14 commitments are not explained”. This means that thePanel found 14 Subversion commitments made during the last 20 days. Two of them don't have required explanations. The project manager will know what to do in order to improve this situation and get a higher quality mark here. Current quality mark is “3”.

Each project management process area has its own list of quality requirements, organized in order of importance (by their weights). The title of the web page indicates current process area (pin 103), which is “Scope Management”. The project manager (or any other project stakeholder) can navigate between process areas with the help of the left-side navigation menu (pin 104).

On the screenshot, there is a project management menu (pin 104), a list of quality requirements (pin 101), and a list of corespondent quality metrics (pin 102).

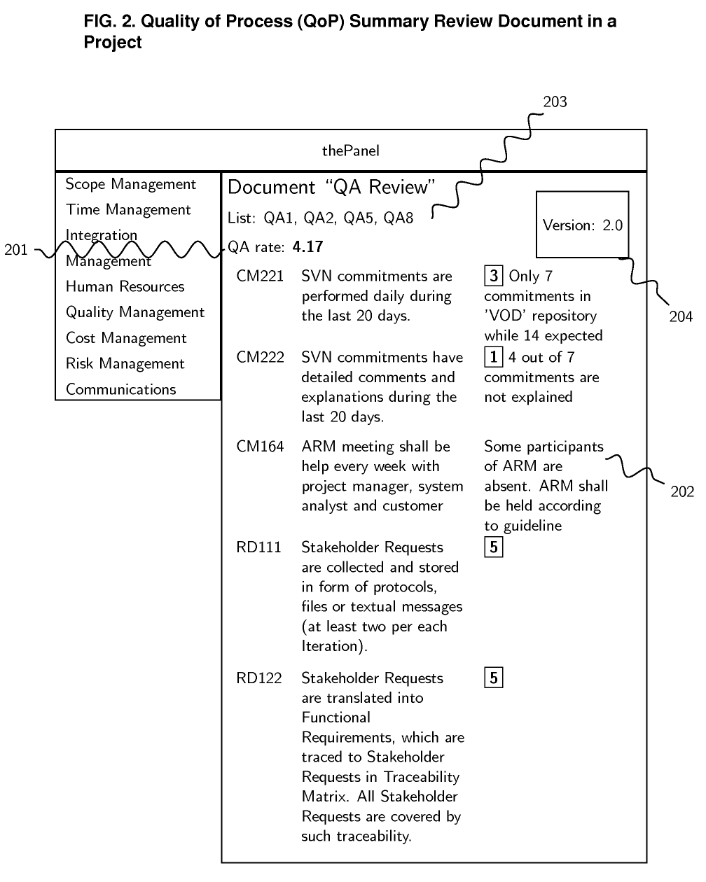

Quality requirements could be gathered in a document, called “Quality Assurance (QA) Review”, as shown on FIG. 2. A QA Review is created by a quality engineer periodically and may include manual quality metrics. Manual metrics are measured by a human being, not a computer. The numbers obtained (metrics) are then used together with computer-calculated numbers.

Thus, the quality of process could be analyzed and estimated in a computer-human combined approach. A good example is the metric for a quality requirement “ARM Meeting shall be help according to guidelines and all participants shall be present”. The quality metric (pin 202) is set by a quality reviewer marking “4” because not all participants took participation in the meeting.

If quality of process does not include any manual metrics, a QA Review document is useless. In such case QoP is calculated by software modules on-fly and the summary is available in any moment of time.

On the other hand, when there are a certain amount of quality metrics calculated manually, by human being, the summary document is necessary. Only the information in such document could be used for motivation and analysis purposes.

The QA Review document includes a document status icon and details (date of creation, author, version, pin 204). QA Review has a final quality rate, in [1; 5] interval (pin 201), which is used for the project managers' motivation and project quality control.

Project artifacts has a list of QA Reviews, created and approved at least once a week. List of all QA Reviews is available for project stakeholders, pin 203.

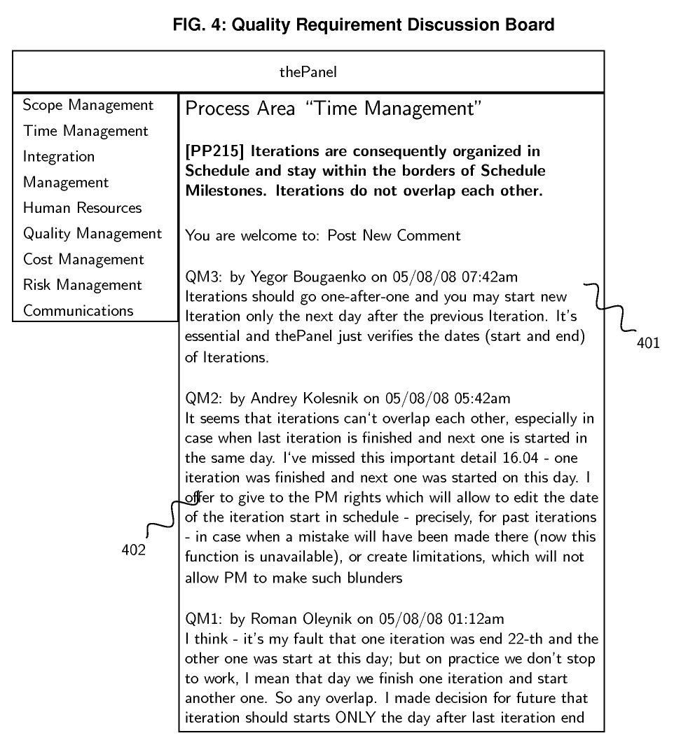

FIG. 4 shows a screenshot with a quality requirement discussion board. In thePanel software system all project stakeholders may discuss quality requirements, raise questions or concerns (pin 402, pin 401). Such discussion boards are reviewed by management and certain questions find their answers. Some questions are deleted when they become obsolete.

This board could be treated as a holder of knowledge about quality in the company.

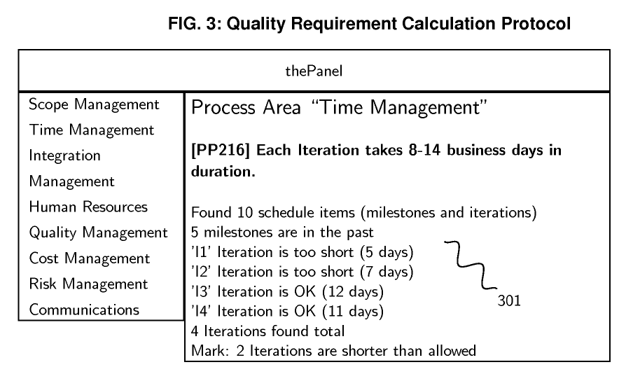

FIG. 3 has a screenshot of quality metric calculation protocol. This protocol explains the details of quality metric for the project stakeholder. The protocol could be very long, if the quality metric is complex.

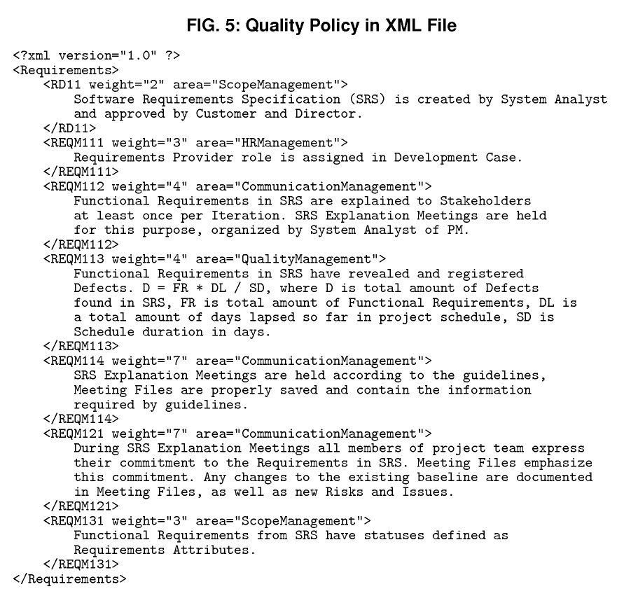

Quality requirements could be listed in XML format, together with weights and comments, in necessary, as shown on FIG. 5. We use XML format in thePanel software because it's both human and computer friendly. The process engineer can make corrections into this file, and the software will easily translate them into business logic. thePanel software has over 150 quality requirements that cover all nine process areas of project management: Scope Management, Cost Management, Integration Management, Communication Management, Human Resource Management, Quality Management, Risk Management, and Procurement Management.

Quality requirements defined in thePanel cover the scope of CMMI Level 3 recommendations to software development process.

Quality requirements are out of scope of this invention, since they are derived from third-party documents and standards, like IEEE set of standards, CMMI, ISO 9001 and PMBOK.

FIG. 5 contains just a small slice of XML files used in thePanel. There are 27 files with 150+ quality requirements.

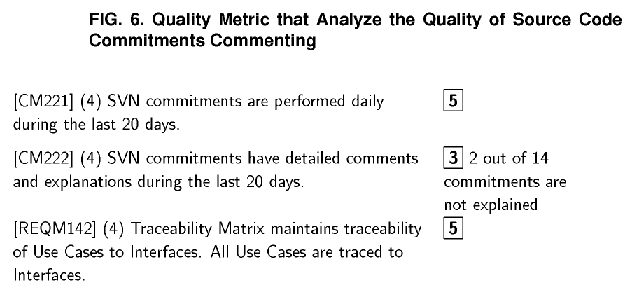

There is one sample requirement screen-shot from thePanel software, on FIG. 6, that shows how project managers and other project stakeholders may review the results of individual quality requirement calculation.

Quality requirement CM222 says that Subversion commitments shall be commented properly. ThePanel in this requirement checks only the last 20 days of project lifecycle. This requirement is derived from the CMMI Configuration Management (CM) process area.

The quality metric for this requirement is calculated by a software module, which goes to the Subversion server, gets the latest log information and parses the received XML report. After a brief analysis of the received data, thePanel gives mark “3” to this quality requirement, and comments on this decision.

Such a quality analysis approach is very clear for project managers and all other project stakeholders, since it gives very straight-forward instructions on what to do in order to improve quality. No mentoring, coaching or personal management are required. The project manager knows exactly what to do.

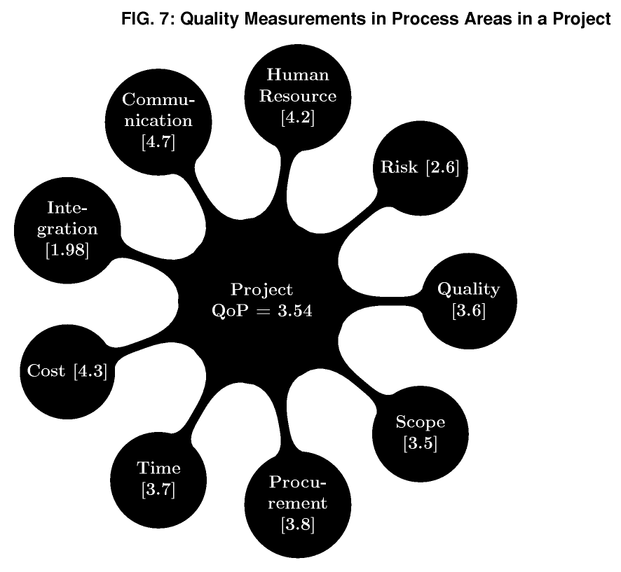

FIG. 7 shows the interconnection between process areas and the project's QoP final measurement. Each process area has its own quality requirements. They are related to certain documents and tasks. Calculated together they constitute a final quality of process measurement.

If we measure the quality of process of some non-project management activity, we should define our own process areas and specify quality requirements for them. In any case, final algorithms will be the same: calculate individual quality metrics, sum them together using weights.

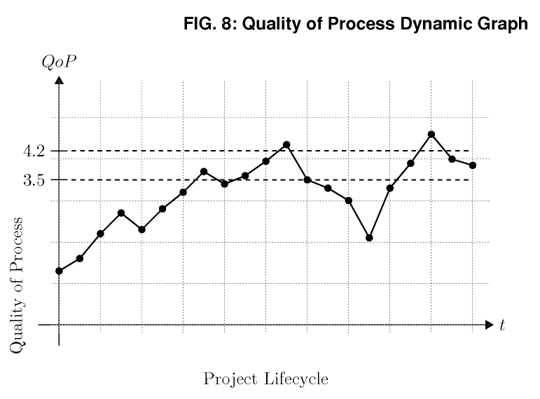

FIG. 8 is a visual presentation of QoP calculations during the project lifecycle. This graph could be used for motivation purposes. For example, the project manager gets awards when quality of process is bigger than 4.2, and get penalties if it is lower than 3.5.

In thePanel software we define a “tolerance area” which is between the bottom and the top values of QoP for each project. These values are 3.5 and 4.2. It means that if the value of QoP is between these values, the project quality of process is considered as “acceptable”. If the value of QoP is lower than 3.5, the project manager would get penalties. If it is higher, the project manager gets bonuses.

This motivation approach is very clear and simple for workers. They understand the goals and make necessary efforts to keep the quality of process higher than the threshold.

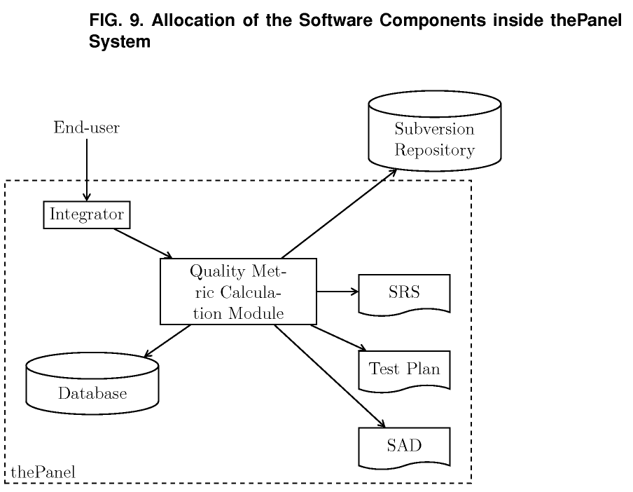

FIG. 9 shows how thePanel components are organized architecturally. The end-user communicates with thePanel through a simple web interface (some screenshots are shown on FIG. 1 and FIG. 2). “Integrator” is a software module, which collects all quality metrics together, calculates weighted average, and returns results to the end-user.

“Quality Metric Calculation Module” has a big amount (over 150) of small software modules, responsible for quality metrics calculation. These modules communicate with “Database”, a collection of documents and third-party systems, like “Subversion Repository”.

The documents (“SRS”, “Test Plan”, “SAD” and over 30 others) are maintained in thePanel in electronic format. This fact makes it pretty simple for “Quality Metric Calculation Module” to get the latest information about the statuses of the documents, their content and they approval states.

However, some of the documents, like source code or test coverage XML reports, are stored outside of thePanel. “Quality Metric Calculation Module” regularly connects to such third-party systems and grabs information from them.

The whole process is totally transparent for the end-user, who sees just the quality of process measurement in thePanel web interface.

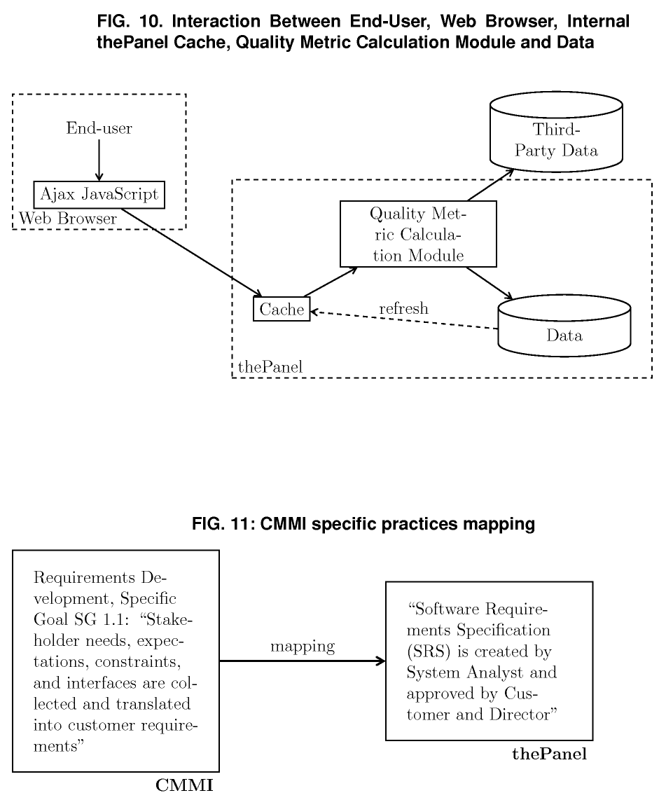

FIG. 10 diagram explains the usage of cache and Ajax in thePanel software.

Each quality metric calculation takes a certain amount of time. Moreover, some of them can be calculated only with the information provided by third-party systems, like Subversion source-code storage system or Bugzilla defect tracking software, etc. Some metrics may take up to 120 seconds in calculation.

To avoid long delays in web page creation, there are two methods used. First, is the asynchronous delivery of quality metrics to the end-user, with the help of JavaScript xmlHttpRequest function. The use of this method (also called Ajax) allows thePanel software to show a web page with a list of quality requirements pretty fast (1-2 seconds). Then, quality metrics are calculated and delivered to the end-user's web browser asynchronously, as soon as they are ready. This process may take up to 120 seconds in duration, but it's much more user friendly. Interaction between end-user and thePanel is done through the module named “Ajax JavaScript” on the diagram.

Secondly, thePanel software has an internal data-caching system. This system (named “cache” on the diagram) stores the results of quality metrics calculation and returns them, if they are requested again. If one and the same quality requirement is requested by the end-user, the calculation is done only once. This approach reduces the total amount of time required to calculate all quality requirements and significantly reduce server load.

Internal cache system is refreshed automatically as soon as any changes are made to the data (dashed line “refresh” on the diagram). Cached quality metrics are just destroyed, if the data which are behind them were changed.

This mechanism is absolutely transparent for the end-user, but gives significant advantages for the server and thePanel software.

FIG. 11 presents a sample mapping of CMMI Specific Practice (from “Requirements Development”, SP1.1) to the quality requirement, that is used in thePanel software. Industry standards (like CMMI, IEEE, PMBOK, etc) usually provide recommendations, without any specific instructions. They don't say anything about exact document names, formats or required amount of information. In the example on FIG. 11, CMMI Specific Practice requires that software requirements are defined in some document. This document should be built on the base of stakeholders' needs, expectations and constraints. There is nothing about format of the document, who should approve the document, how big it should be, etc.

The requirement defined in thePanel software says explicitly that the SRS document should be created and approved by two persons (Customer and Director). This fact is easy to validate by a simple software checker-module.

Other requirements are defined very precisely, in order to give explicit instructions to the project manager and project team.

1 U.S. patent Documents

| | | |
|---|---|---|
| 7,437,268 | October 2008 | Pathak, et al. |
| 7,418,491 | August 2008 | Childress, et al. |
| 7,415,375 | August 2008 | Shakman, et al. |
| 7,409,357 | August 2008 | Schaf, et al. |
| 6,321,206 | November 2001 | Honarvar |
| 6,144,962 | November 2000 | Weinberg, et al. |
| 12/001,398 | December 2007 | Williams |
| 11/947,114 | November 2007 | Takuechi, et al. |
| 11/944,530 | November 2007 | Hernandes, et al. |
| 11/864,618 | September 2007 | Binnie, et al. |
| 11/839,483 | August 2007 | Shafer |
| 11/799,729 | May 2007 | Aoyama, et al. |
| 11/644,577 | December 2006 | Siegrist, et al. |
| 11/636,003 | December 2006 | Taylor |
| 11/617,751 | December 2006 | Xie, et al. |

[1] Carnegie Melon, Software Engineering Institute, CMMI for Development, Version 1.2, CMU/SEI-2006-TR-008, 2006.
[2] IBM Corp. Rational Portfolio Manager, www.ibm.com/software/rational, 2008.
[3] Project Management Institute. Project Management Body of Knowledge (PMBOK) Guide v.3. PMI Press, 3rd edition, 2004.
[4] The Institute of Electrical and Electronics Engineers. IEEE 1016-1998 Recommended Practice for Software Design Descriptions, 1998.
[5] The Institute of Electrical and Electronics Engineers. IEEE 829-1998 Standard for Software Test Documentation, 1998.
[6] The Institute of Electrical and Electronics Engineers. IEEE 830-1998 Recommended Practices for Software Requirements Specification, 1998.
[7] The Institute of Electrical and Electronics Engineers. IEEE 1471-2000 Recommended Practice for Architectural Description of Software-Intensive Systems, 2000.
[8] International Organization for Standardization. ISO 9000, Quality Management System Requirements, 2001.
[9] Object Management Group. Unified Modeling Language (UML), Superstructure, Version 2.0, 2005.
[10] Primavera Systems, Inc. Primavera Project Management Solutions, www.primavera.com, 2008.
[11] Sun Microsystems. Code Conventions For the Java Programming Language, 2008.
[12] wikipedia, http://en.wikipedia.org/wiki/List_of_project_management_software. List of Project Management Software, 2008.

1. A method and software for quality of process measurement comprising:
1. defining a list of quality requirements;
2. setting weight for each quality requirement;
3. developing measuring modules for each requirement to get quality metrics;
4. calculating quality of process as a weighted average of quality metrics;
5. using the calculated quality of process for business purposes.

2. The method and software according to claim 1, wherein the software is at least one of a software, a hardware, and a complex computer system, that includes both software and hardware components.

3. The method according to claim 1, wherein the list of quality requirements is at least one of a flat list, a structured list, a hierarchical list, and a grouped collection, in any form, like computer file, paper document or software code.

4. The method according to claim 1, wherein the weight is at least one of a number in a pre-defined interval, and a literal constant.

5. The method according to claim 1, wherein the measuring module is at least one of a software component, a human being interface (where someone enters the result of measuring, obtained somewhere, according to some rule), and a constant.

6. The method according to claim 1, wherein the weighted average is at least one of a mathematical mean, and another method of calculating.

7. The method according to claim 1, wherein the business purpose is at least one of a team motivation, a feasibility project analysis, a risk analysis, and another business decision.
